(19) United States
(12) Patent Application Publication
(10) Pub. No.: US 2025/0118777 A1
(43) Pub. Date: Apr. 10, 2025

(54) CHROMIUM ALLOY CONTAINER AND METAL-SUPPORTED ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/921,119

(22) Filed: Oct. 21, 2024

Related U.S. Application Data
(63) Continuation of application No. PCT/JP2023/036372, filed on Oct. 5, 2023.

(51) Int. Cl. H01M 8/0273; C22C 27/06; C25B 9/60; H01M 8/0276; H01M 8/0282

(52) U.S. Cl. CPC H01M 8/0273; C22C 27/06; C25B 9/60; H01M 8/0276; H01M 8/0282

(57) ABSTRACT

A chromium alloy container has an internal space. The chromium alloy container includes a first alloy member constituted by an alloy containing chromium, a second alloy member constituted by an alloy containing chromium, and an adhering portion adhering the first alloy member and the second alloy member to each other. The adhering portion is constituted by an oxide containing chromium as a main component. The adhering portion has a void therein.

### CROSS-REFERENCE TO RELATED APPLICATION

This is a continuation of PCT/JP2023/036372, filed Oct. 5, 2023, the entire contents of which are hereby incorporated by reference.

### TECHNICAL FIELD

The present invention relates to a chromium alloy container and a metal-supported electrochemical cell.

### BACKGROUND ART

A chromium alloy container for housing a fuel cell is disclosed in JP 2015-156352A. The chromium alloy container includes a first interconnector, a second interconnector, a separator, an anode frame, and a glass seal.

The first interconnector is connected to an air electrode of the fuel cell. The second interconnector is connected to an anode current collecting layer of the fuel cell. The separator is connected to a solid electrolyte of the fuel cell and separates flow paths for fuel gas and oxidant gas. The anode frame is disposed between the separator and the second interconnector. The glass seal adheres the first interconnector and the separator to each other.

The first interconnector, the second interconnector, the separator, and the anode frame are each constituted by a chromium alloy (e.g., SUS430 or SUS444). The glass seal is constituted by a glass material.

### SUMMARY

In the chromium alloy container described in JP 2015-156352A, when the chromium contained in the first interconnector and the separator diffuses into the glass seal, the composition of the glass seal changes, and the strength is likely to decrease. As a result, the glass seal may deform or crack, thus making it impossible to maintain adhesion between alloy members for a long period of time. This is not limited to containers that house fuel cells, and is a common problem for chromium alloy containers in general.

An object of the present invention is to provide a chromium alloy container and a metal-supported electrochemical cell in which adhesion between alloy members can be maintained for a long period of time.

A chromium alloy container according to a first aspect of the present invention has an internal space. The chromium alloy container includes a first alloy member constituted by an alloy containing chromium, a second alloy member constituted by an alloy containing chromium, and an adhering portion adhering the first alloy member and the second alloy member to each other. The adhering portion is constituted by an oxide containing chromium as a main component. The adhering portion has a void therein.

A chromium alloy container according to a second aspect of the present invention is the chromium alloy container according to the first aspect, wherein the void is spaced apart from the first alloy member and the second alloy member.

A chromium alloy container according to a third aspect of the present invention is the chromium alloy container according to the first or second aspect, wherein the void is elongated in a thickness direction of the adhering portion.

A chromium alloy container according to a fourth aspect of the present invention is the chromium alloy container according to any of the first to third aspects, wherein the void is elongated in a planar direction perpendicular to a thickness direction of the adhering portion.

A chromium alloy container according to a fifth aspect of the present invention is the chromium alloy container according to any of the first to third aspects, wherein the void is elongated in a direction inclined with respect to both a thickness direction of the adhering portion and a planar direction perpendicular to the thickness direction.

A chromium alloy container according to a sixth aspect of the present invention is the chromium alloy container according to any of the first to third aspects, wherein the void is located in a center portion in a thickness direction of the adhering portion.

A chromium alloy container according to a seventh aspect of the present invention is the chromium alloy container according to any of the first to sixth aspects, wherein in a thickness direction of the adhering portion, a thickness of the void is less than or equal to ¾ of a thickness of the adhering portion.

A chromium alloy container according to an eighth aspect of the present invention is the chromium alloy container according to any of the first to seventh aspects, wherein in a thickness direction of the adhering portion, a ratio of a thickness of at least either the first alloy member or the second alloy member to a thickness of the void is 20 or more and 500 or less.

A chromium alloy container according to a ninth aspect of the present invention is the chromium alloy container according to any of the first to eighth aspects, wherein in a cross section of the adhering portion, a ratio of an area of the void to an area of the adhering portion is 5% or more and 30% or less.

A chromium alloy container according to a tenth aspect of the present invention is the chromium alloy container according to any of the first to ninth aspects, wherein the adhering portion includes metal particles at least partially embedded in the oxide.

A chromium alloy container according to an eleventh aspect of the present invention is the chromium alloy container according to any of the first to tenth aspects, wherein a chromium content among metal elements in the oxide is 50 mol % or more.

A chromium alloy container according to a twelfth aspect of the present invention is the chromium alloy container according to any of the first to eleventh aspects, wherein the oxide is constituted by at least either chromium oxide or chromium manganese oxide.

A chromium alloy container according to a thirteenth aspect of the present invention is the chromium alloy container according to any of the first to twelfth aspects, wherein the oxide is crystalline.

A chromium alloy container according to a fourteenth aspect of the present invention is the chromium alloy container according to the thirteenth aspect, wherein the oxide has a spinel type crystal structure or a corundum type crystal structure.

A chromium alloy container according to a fifteenth aspect of the present invention is the chromium alloy container according to any of the first to fourteenth aspects, wherein the adhering portion is a seal for sealing the internal space.

A chromium alloy container according to a sixteenth aspect of the present invention is the chromium alloy container according to any of the first to fourteenth aspects, wherein the second alloy member has an embossed portion in contact with the first alloy member. The adhering portion adheres the embossed portion to the first alloy member.

A metal-supported electrochemical cell according to a seventeenth aspect of the present invention includes the chromium alloy container according to any of the first to sixteenth aspects, and a cell body portion disposed on the chromium alloy container. The first alloy member has a plurality of communication holes in communication with the internal space. The cell body portion is disposed on the first alloy member in such a manner as to cover the plurality of communication holes.

According to the present invention, it is possible to provide a chromium alloy container and a metal-supported electrochemical cell in which adhesion between alloy members can be maintained for a long period of time.

### BRIEF DESCRIPTION OF DRAWINGS

FIG. 1 is a plan view of an electrolysis cell according to a first embodiment.

FIG. 2 is a cross-sectional view taken along line A-A in FIG. 1.

FIG. 3 is an enlarged view of a portion of FIG. 2.

FIG. 4 is a cross-sectional view of an electrolysis cell according to a second embodiment.

FIG. 5 is an enlarged view of a portion of FIG. 4.

### DESCRIPTION OF EMBODIMENTS

### 1. First Embodiment

### (Electrolysis Cell 1)

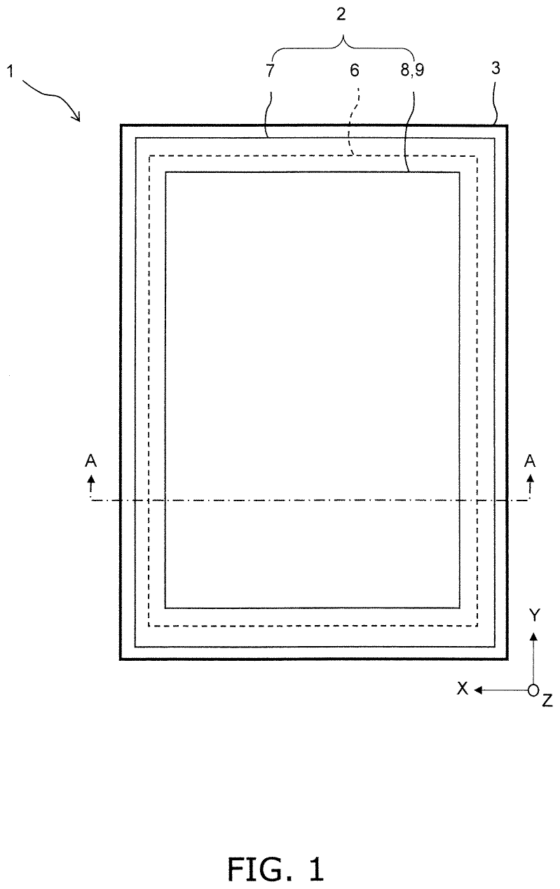

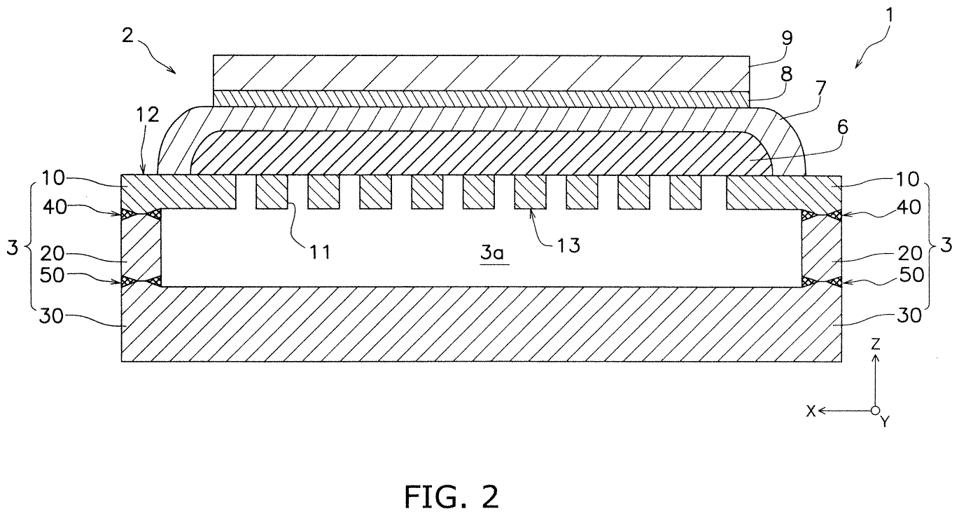

FIG. 1 is a plan view of an electrolysis cell 1 according to a first embodiment. FIG. 2 is a cross-sectional view taken along line A-A in FIG. 1.

The electrolysis cell 1 is an example of a “metal-supported electrochemical cell” according to the present invention.

The electrolysis cell 1 is shaped as a plate extending in an X-axis direction and a Y-axis direction. In the present embodiment, the electrolysis cell 1 is shaped as a rectangle extending in the Y-axis direction when viewed in a plan view from a Z-axis direction perpendicular to the X-axis direction and the Y-axis direction. However, the planar shape of the electrolysis cell 1 is not particularly limited, and may be a polygon other than a rectangle, such as an ellipse, a circle, or the like.

As shown in FIGS. 1 and 2, the electrolysis cell 1 includes a cell body portion 2 and a chromium alloy container 3.

### (Cell Body Portion 2)

The cell body portion 2 is disposed on the chromium alloy container 3. The cell body portion 2 is supported by a later-described metal support 10 of the chromium alloy container 3. The cell body portion 2 includes a hydrogen electrode 6 (cathode), an electrolyte 7, a reaction prevention layer 8, and an oxygen electrode 9 (anode).

The hydrogen electrode 6, the electrolyte 7, the reaction prevention layer 8, and the oxygen electrode 9 are stacked in this order from the chromium alloy container 3 side in the Z-axis direction. The hydrogen electrode 6, the electrolyte 7, and the oxygen electrode 9 are essential components, whereas the reaction prevention layer 8 is an optional component.

### [Hydrogen Electrode 6]

The hydrogen electrode 6 is disposed on a first main surface 12 of the metal support 10.

A raw material gas is supplied to the hydrogen electrode 6 through supply holes 11 in the metal support 10. The raw material gas contains at least water vapor (H₂O).

When the raw material gas contains only H₂O, the hydrogen electrode 6 produces H₂ from the raw material gas in accordance with water electrolysis, which is the electrochemical reaction shown in the following formula (1).

Hydrogen electrode 6: H₂O+2e⁻→H₂+O²⁻ (1)

When the raw material gas contains CO₂ in addition to H₂O, the hydrogen electrode 6 produces H₂, CO, and O²⁻ from the raw material gas in accordance with co-electrolysis, which are the co-electrochemical reactions shown in the following formulas (2), (3), and (4).

Hydrogen electrode 6: CO₂+H₂O+4^{e-}→CO+H₂+2O²⁻ (2)

H₂O electrochemical reaction: H₂O+2e⁻→H₂+O²⁻ (3)

CO₂ electrochemical reaction: CO₂+2e⁻→CO+O²⁻ (4)

H₂ produced in the hydrogen electrode 6 flows out from the supply holes 11 of the metal support 10 into a later-described internal space 3a.

The hydrogen electrode 6 is a porous body that has electronic conductivity. The hydrogen electrode 6 contains nickel (Ni). In the case of co-electrolysis, Ni functions as an electronic conductor, and also functions as a thermal catalyst that promotes the thermal reaction between the produced H₂ and the CO₂ contained in the raw material gas to maintain an appropriate gas composition for methanation, Fischer-Tropsch (FT) synthesis, and the like. The Ni contained in the hydrogen electrode 6 is essentially present in the form of metal Ni during operation of the electrolysis cell 1, but may also partially be present in the form of nickel oxide (NiO).

The hydrogen electrode 6 may contain an ion conductive material. Examples of the ion conductive material that can be used include yttria-stabilized zirconia (YSZ), calcia-stabilized zirconia (CSZ), scandia-stabilized zirconia (ScSZ), gadolinium-doped ceria (GDC), samarium-doped ceria (SDC), (La,Sr)(Cr,Mn)O₃, (La,Sr)TiO₃, Sr₂(Fe,Mo)₂O₆, (La,Sr)VO₃, (La,Sr)FeO₃, and mixed materials containing two or more of these.

The thickness of the hydrogen electrode 6 is not particularly limited, but can be, for example, 1 μm or more and 100 μm or less. The value of the thermal expansion coefficient of the hydrogen electrode 6 is not particularly limited, but can be, for example, 12×10⁻⁶/° C. or more and 20×10⁻⁶/° C. or less.

The method for forming the hydrogen electrode 6 is not particularly limited, and may be a firing method, a spray coating method (such as a thermal spray method, an aerosol deposition method, an aerosol gas deposition method, a powder jet deposition method, a particle jet deposition method, or a cold spray method), a PVD method (such as a sputtering method or a pulsed laser deposition method), or a CVD method, for example.

### [Electrolyte 7]

The electrolyte 7 is formed on the hydrogen electrode 6. The electrolyte 7 is disposed between the hydrogen electrode 6 and the oxygen electrode 9. In the present embodiment, the electrolyte 7 is sandwiched between the hydrogen electrode 6 and the reaction prevention layer 8 and is connected to both of them.

The electrolyte 7 covers the hydrogen electrode 6 and also covers the region of the first main surface 12 of the metal support 10 that is exposed from the hydrogen electrode 6.

The electrolyte 7 is a dense body that has oxide ion conductivity. The electrolyte 7 transfers O²⁻ produced at the hydrogen electrode 6 toward the oxygen electrode 9. The electrolyte 7 is constituted by an oxide ion conductive material. The electrolyte 7 can be constituted by, for example, YSZ, GDC, ScSZ, SDC, LSGM (lanthanum gallate), or the like, with YSZ being particularly preferable.

The thickness of the electrolyte 7 is not particularly limited, but can be, for example, 1 μm or more and 100 μm or less. The value of the thermal expansion coefficient of the electrolyte 7 is not particularly limited, but can be, for example, 10×10⁻⁶/° C. or more and 12×10⁻⁶/° C. or less.

The method for forming the electrolyte 7 is not particularly limited, and a firing method, a spray coating method, a PVD method, a CVD method, or the like can be used.

### [Reaction Prevention Layer 8]

The reaction prevention layer 8 is disposed between the electrolyte 7 and the oxygen electrode 9. The reaction prevention layer 8 is disposed on the side of the electrolyte 7 opposite to the hydrogen electrode 6 side. The reaction prevention layer 8 suppresses the formation of a layer with high electrical resistance caused by constituent elements of the electrolyte 7 reacting with constituent elements of the oxygen electrode 9.

The reaction prevention layer 8 is constituted by an oxide ion conductive material. The reaction prevention layer 8 can be constituted by GDC, SDC, or the like.

The porosity of the reaction prevention layer 8 is not particularly limited, but can be, for example, 0.1% or more and 50% or less. The thickness of the reaction prevention layer 8 is not particularly limited, but may be, for example, 1 μm or more and 50 μm or less.

The method for forming the reaction prevention layer 8 is not particularly limited, and a firing method, a spray coating method, a PVD method, a CVD method, or the like can be used.

### [Oxygen Electrode 9]

The oxygen electrode 9 is disposed on the side of the electrolyte 7 opposite to the hydrogen electrode 6 side. In the present embodiment, the reaction prevention layer 8 is disposed between the electrolyte 7 and the oxygen electrode 9, and therefore the oxygen electrode 9 is connected to the reaction prevention layer 8. When the reaction prevention layer 8 is not disposed between the electrolyte 7 and the oxygen electrode 9, the oxygen electrode 9 is connected to the electrolyte 7.

The oxygen electrode 9 produces O₂ from O²⁻ transferred from the hydrogen electrode 6 via the electrolyte 7 in accordance with the chemical reaction of the following formula (5).

Oxygen electrode 9: 2O²⁻→O₂+4e⁻ (5)

The oxygen electrode 9 is a porous body that has oxide ion conductivity and electronic conductivity. The oxygen electrode 9 can be formed of a composite material containing an oxide ion conductive material (such as GDC) and one or more of (La,Sr)(Co,Fe)O₃, (La,Sr)FeO₃, La(Ni,Fe)O₃, (La,Sr)CoO₃, and (Sm,Sr)CoO₃.

The porosity of the oxygen electrode 9 is not particularly limited, but can be, for example, 20% or more and 60% or less. The thickness of the oxygen electrode 9 is not particularly limited, but can be, for example, 1 μm or more and 100 μm or less.

The method for forming the oxygen electrode 9 is not particularly limited, and a firing method, a spray coating method, a PVD method, a CVD method, or the like can be used.

### (Chromium Alloy Container 3)

The chromium alloy container 3 includes the internal space 3a through which the raw material gas supplied to the hydrogen electrode 6 and the reducing gas (H₂ in the present embodiment) produced in the hydrogen electrode 6 flow.

In the present embodiment, the chromium alloy container 3 includes the metal support 10, a frame 20, an interconnector 30, a first sealing portion 40, and a second sealing portion 50. The internal space 3a is a space surrounded by the metal support 10, the frame 20, the interconnector 30, the first sealing portion 40, and the second sealing portion 50.

In the present embodiment, either the metal support 10 or the frame 20 is an example of the “first alloy member” according to the present invention, and the other one is an example of the “second alloy member” according to the present invention. Also, in the present embodiment, either the frame 20 or the interconnector 30 is an example of the “first alloy member” according to the present invention, and the other one is an example of the “second alloy member” according to the present invention.

### [Metal Support 10]

The metal support 10 supports the cell body portion 2. In the present embodiment, the metal support 10 is formed in a plate shape. The metal support 10 may be shaped as a flat plate or a curved plate.

The metal support 10 is only required to be able to support the cell body portion 2, and the thickness is not particularly limited, but can be, for example, 0.1 mm or more and 2.0 mm or less.

As shown in FIG. 2, the metal support 10 includes the supply holes 11, the first main surface 12, and the second main surface 13.

The supply holes 11 pass through the metal support 10 from the first main surface 12 to the second main surface 13. The supply holes 11 are open at both the first main surface 12 and the second main surface 13. The supply holes 11 are covered by the cell body portion 2. Specifically, the openings of the supply holes 11 on the first main surface 12 side are covered by the hydrogen electrode 6. The openings of the supply holes 11 on the second main surface 13 side are in communication with the internal space 3a.

The supply holes 11 can be formed by mechanical processing (e.g., punching), laser processing, chemical processing (e.g., etching), or the like.

In the present embodiment, the supply holes 11 extend straight along the Z-axis direction. However, the supply holes 11 may be inclined with respect to the Z-axis direction, and do not need to be linear. Moreover, the supply holes 11 may be connected to each other.

The first main surface 12 is provided on the side opposite to the second main surface 13. The cell body portion 2 is disposed on the first main surface 12. The frame 20 is joined to the second main surface 13 via the first sealing portion 40.

The metal support 10 is constituted by an alloy containing Cr (chromium). Examples of such alloys include Fe—Cr alloy steel (such as stainless steel) and Ni—Cr alloy steel. The Cr content in the metal support 10 is not particularly limited, but can be set to 4 mass % or more and 30 mass % or less.

The metal support 10 may contain Ti (titanium) and/or Zr (zirconium). The Ti content in the metal support 10 is not particularly limited, but can be set to 0.01 mol % or more and 1.0 mol % or less. The Zr content in the metal support 10 is not particularly limited, but can be set to 0.01 mol % or more and 0.4 mol % or less. The metal support 10 may contain Ti as TiO₂ (titania) and Zr as ZrO₂ (zirconia).

### [Frame 20]

The frame 20 is a spacer for forming the internal space 3a. In the present embodiment, the frame 20 is formed in an annular shape.

The frame 20 is joined to the metal support 10 via the first sealing portion 40, and is joined to the interconnector 30 via the second sealing portion 50.

The thickness of the frame 20 is not particularly limited, but may be, for example, 0.1 mm or more and 2.0 mm or less.

The frame 20 is constituted by an alloy containing Cr. Examples of such alloys include Fe—Cr alloy steel and Ni—Cr alloy steel. The Cr content in the frame 20 is not particularly limited, but can be set to 4 mass % or more and 30 mass % or less. The composition of the frame 20 may be the same as or different from that of the metal support 10.

### [Interconnector 30]

The interconnector 30 is disposed on the side of the frame 20 opposite to the metal support 10 side. The interconnector 30 is a member for electrically connecting the electrolysis cell 1 to an external power source or another electrolysis cell.

In the present embodiment, the interconnector 30 is formed in a plate shape. The interconnector 30 may be shaped as a flat plate or a curved plate.

The interconnector 30 is joined to the frame 20 via the second sealing portion 50.

The thickness of the interconnector 30 is not particularly limited, but can be, for example, 0.1 mm or more and 2.0 mm or less.

The interconnector 30 is constituted by an alloy containing Cr. Examples of such alloys include Fe—Cr alloy steel and Ni—Cr alloy steel. The Cr content in the interconnector 30 is not particularly limited, but can be set to 4 mass % or more and 30 mass % or less. The composition of the interconnector 30 may be the same as or different from that of the metal support 10. The composition of the interconnector 30 may be the same as or different from that of the frame 20.

### [First Sealing Portion 40]

The first sealing portion 40 is disposed between the metal support 10 and the frame 20. The first sealing portion 40 is joined to both the metal support 10 and the frame 20.

The first sealing portion 40 seals the gap between the metal support 10 and the frame 20. This prevents the raw material gas supplied to the hydrogen electrode 6 and the reducing gas produced in the hydrogen electrode 6 from leaking to the outside through the gap between the metal support 10 and the frame 20. The detailed configuration of the first sealing portion 40 will be described later.

### [Second Sealing Portion 50]

The second sealing portion 50 is disposed between the frame 20 and the interconnector 30. The second sealing portion 50 is joined to both the frame 20 and the interconnector 30.

The second sealing portion 50 seals the gap between the frame 20 and the interconnector 30. This prevents the raw material gas supplied to the hydrogen electrode 6 and the reducing gas produced in the hydrogen electrode 6 from leaking to the outside through the gap between the frame 20 and the interconnector 30.

The configuration of the second sealing portion 50 is the same as the configuration of the first sealing portion 40, which will be described next, and therefore, in the present embodiment, a description will not be given for the configuration of the second sealing portion 50.

### (Detailed Configuration of First Sealing Portion 40)

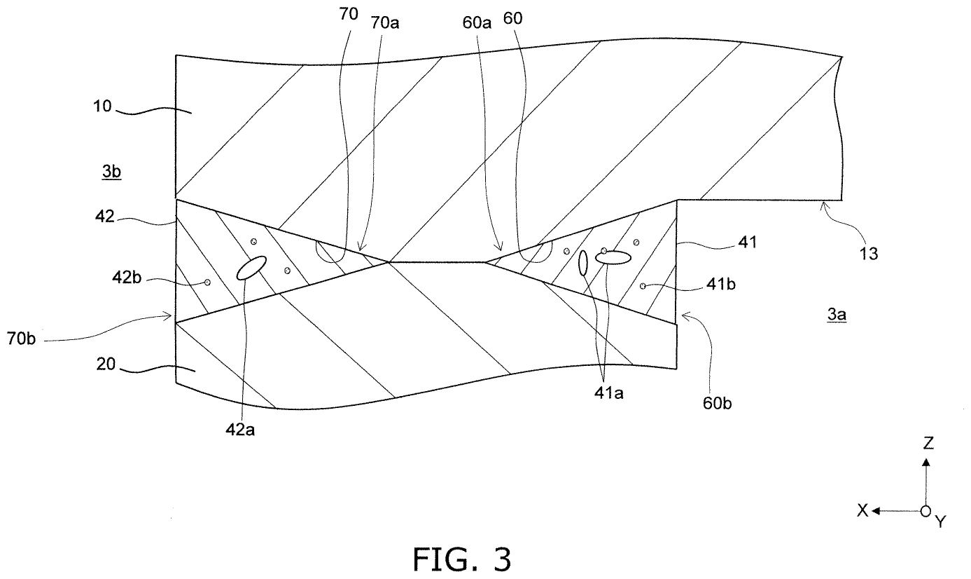

FIG. 3 is an enlarged view of a portion of FIG. 2. A cross section of the first sealing portion 40 is shown in FIG. 3. The cross section illustrated in FIG. 3 is perpendicular to the first main surface 12 of the metal support 10.

The first sealing portion 40 includes a first adhering portion 41 and a second adhering portion 42. The first adhering portion 41 and the second adhering portion 42 are each an example of the “adhering portion” according to the present invention.

### [First Adhering Portion 41]

The first adhering portion 41 is disposed between the metal support 10 and the frame 20. The first adhering portion 41 is sandwiched between the metal support 10 and the frame 20. The first adhering portion 41 is formed in an annular shape so as to surround the internal space 3a. The first adhering portion 41 functions as a seal for sealing the internal space 3a.

In the present embodiment, the first adhering portion 41 is embedded in a bottomed recess 60 formed between the metal support 10 and the frame 20. The cross section of the bottomed recess 60 is wedge-shaped. The bottomed recess 60 has a deepest portion 60a and an opening 60b. The opening 60b is open toward the internal space 3a. The first adhering portion 41 is exposed to the internal space 3a.

The first adhering portion 41 is constituted by an oxide containing Cr as a main component (hereinafter, abbreviated as “Cr oxide”). This makes it possible to suppress the diffusion of Cr from the metal support 10 and the frame 20 to the first adhering portion 41 during the manufacture and operation of the electrolysis cell 1. Furthermore, even if Cr diffuses from the metal support 10 and the frame 20 to the first adhering portion 41, the effect on the composition of the first adhering portion 41 is small, thus making it possible to suppress a decrease in the strength of the first adhering portion 41. Furthermore, since the metal support 10, the frame 20, and the first adhering portion 41 all contain Cr, the adhesion therebetween can be improved. Therefore, the adhesion between the metal support 10 and the frame 20 can be maintained for a long period of time.

In the present embodiment, the term “containing Cr as a main component” means that when the composition of the Cr oxide constituting the first adhering portion 41 is analyzed using an energy dispersive spectroscopy (EDS) device, the Cr content is the highest among the metal elements in the Cr oxide. The Cr content is not particularly limited, but can be, for example, 20 mol % or more and 100 mol % or less.

It is preferable that the Cr content among the metal elements in the Cr oxide constituting the first adhering portion 41 is 50 mol % or more. This makes it possible to significantly suppress the diffusion of Cr contained in the metal support 10 and the frame 20 to the first adhering portion 41.

It is preferable that the Cr oxide constituting the first adhering portion 41 is constituted by at least either chromium oxide or chromium manganese oxide. A property of these oxides is that the diffusion of Cr is particularly unlikely to occur, and therefore the durability of the first adhering portion 41 can be improved.

One example of a chromium oxide is Cr₂O₃. Examples of chromium manganese oxides include MnCr₂O₄ (spinel) and Mn_{1,5}Cr_{1,5}O₄ (spinel).

It is preferable that the Cr oxide constituting the first adhering portion 41 is crystalline. Accordingly, even when the electrolysis cell 1 is operated for a long period, it is possible to avoid the case where the first adhering portion 41 becomes damaged due to a phase transition of the Cr oxide from amorphous to crystalline.

It is preferable that the Cr oxide constituting the first adhering portion 41 has a spinel type or a corundum type crystal structure. These crystal structures are highly symmetrical, and therefore the thermal stress resistance of the first adhering portion 41 can be improved. Also, Cr oxides having these crystal structures have good bonding properties at the interfaces with the metal support 10 and the frame 20, which are constituted by an alloy containing Cr, thus making it possible to improve the bonding strength between the first adhering portion 41 and the metal support 10 and between the first adhering portion 41 and the frame 20.

Here, the first adhering portion 41 includes voids 41a therein, as shown in FIG. 3. This makes it possible for cracks formed in the first adhering portion 41 to be stopped at the voids 41a. Therefore, brittle fracture of the first adhering portion 41 can be suppressed, and the adhesion between the metal support 10 and the frame 20 can be further maintained for a long period of time.

In the present embodiment, the first adhering portion 41 has two voids 41a, but the number of voids 41a in one cross section is not particularly limited, and may be one or three or more

It is preferable that, as shown in FIG. 3, the voids 41a are spaced apart from the metal support 10 and the frame 20. This makes it possible to increase the adhesion area between the first adhering portion 41 and the metal support 10 and between the first adhering portion 41 and the frame 20, thus making it possible to improve the adhesion between the first adhering portion 41 and the metal support 10 and between the first adhering portion 41 and the frame 20.

The voids 41a may be elongated in the thickness direction parallel to the Z-axis direction. This allows cracks extending along the planar direction perpendicular to the thickness direction to be stopped over a wide range by the voids 41a. The thickness direction is a direction perpendicular to the first main surface 12 of the metal support 10. Being elongated in the thickness direction means that the thickness of the voids 41a in the thickness direction is greater than the width of the voids 41a in the planar direction.

The voids 41a may be elongated in the planar direction perpendicular to the Z-axis direction. This allows cracks extending along the thickness direction to be stopped over a wide range by the voids 41a. Here, being elongated in the planar direction means that the thickness of the voids 41a in the thickness direction is smaller than the width of the voids 41a in the planar direction.

The voids 41a may be elongated in a direction inclined with respect to both the thickness direction and the planar direction. This allows both cracks extending in the thickness direction and cracks extending in the planar direction to be stopped by the voids 41a in a well-balanced manner. In this case, the thickness of the voids 41a in the thickness direction may be approximately the same as the width of the voids 41a in the planar direction.

It is preferable that the voids 41a are located in the center portion in the thickness direction of the first adhering portion 41. This makes it possible to reduce the difference in strength of the first adhering portion 41 on the metal support 10 side of the voids 41a and the frame 20 side of the voids 41a, and therefore makes it possible to suppress a decrease in the mechanical reliability of the first adhering portion 41. It is more preferable that the voids 41a are entirely contained in the center portion of the first adhering portion 41 in the thickness direction. The center portion in the thickness direction refers to the portion located in the center when the first adhering portion 41 is divided into three equal parts, on an imaginary line that is parallel to the thickness direction and passes through the voids 41a.

It is preferable that the thickness of the voids 41a is less than or equal to ¾ of the thickness of the first adhering portion 41. This makes it possible to suppress a decrease in the strength of the first adhering portion 41 on the metal support 10 side of the voids 41a and the frame 20 side of the voids 41a, thereby making it possible to suppress peeling of the first adhering portion 41 from the metal support 10 and the frame 20. The thickness of the first adhering portion 41 is the sum of the shortest distance between the voids 41a and the metal support 10 in the thickness direction, the shortest distance between the voids 41a in the thickness direction, and the thickness of the voids 41a in the thickness direction.

It is preferable that the ratio of the thickness of at least either the metal support 10 or the frame 20 to the thickness of the voids 41a is 20 or more and 500 or less. By setting the thickness ratio to 20 or more, the cracking stopping effect of the voids 41a can be sufficiently exhibited. Furthermore, by setting the thickness ratio to 500 or less, it is possible to suppress a decrease in the mechanical reliability (strength) of the first adhering portion 41 caused by the presence of the voids 41a.

It is preferable that in a cross section of the first adhering portion 41, the ratio of the area of the voids 41a to the area of the first adhering portion 41 is 5% or more and 30% or less. By setting the area ratio to 5% or more, the cracking stopping effect of the voids 41a can be sufficiently exhibited. Moreover, by setting the area ratio to 30% or less, it is possible to suppress a decrease in the mechanical reliability (strength) of the first adhering portion 41 caused by the presence of the voids 41a.

The area ratio is calculated by the following method. First, a cross section of the first adhering portion 41 along the Z-axis direction is exposed. Next, a backscattered electron image of the cross section of the first adhering portion 41 is obtained at 10,000 times magnification using an SEM device (FE-SEM JSM-7900F, manufactured by JEOL Ltd.). Next, the image analysis software Image-Pro manufactured by MEDIA CYBERNETICS, Inc. is used to identify portions shown in black in the reflected electron image (corresponding to the voids 41a). Then, the area ratio of the voids 41a is calculated by dividing the sum area of the voids 41a by the total area of the reflected electron image of the first adhering portion 41.

It is preferable that the area ratio in the planar end portion of the first adhering portion 41 exposed to the internal space 3a is smaller than the area ratio in the planar center portion. This makes it possible to suppress the case where the reducing gas (H₂ in the present embodiment) flowing through the internal space 3a enters the voids 41a, thereby making it possible to further improve the sealing performance of the first adhering portion 41. The planar center portion of the first adhering portion 41 refers to the portion located in the center when the first adhering portion 41 is divided into three equal parts, on an imaginary line that is parallel to the planar direction and passes through the voids 41a. The planar end portion of the first adhering portion 41 is the portion located on the internal space 3a side of the planar center portion, on the imaginary line.

As shown in FIG. 3, it is preferable that the first adhering portion 41 includes metal particles 41b at least partially embedded in the Cr oxide. This allows the Cr oxide and the metal particles 41b to be combined, and the toughness of the first adhering portion 41 can be improved.

The metal particles 41b may be entirely embedded in the Cr oxide, or may be partially exposed inside the voids 41a. It is preferable that the metal particles 41b contain, as a main component, the same element as the main component of at least either the metal support 10 or the frame 20. This makes it possible to suppress a change in composition of the first adhering portion 41 caused by element diffusion from the metal support 10 and the frame 20. For example, the metal particles 41b can contain Cr or Fe as a main component. Note that being contained as a main component means exhibiting the highest content percentage when the metal particles 41b are subjected to elemental analysis.

The first adhering portion 41 can be formed by applying a paste containing Cr oxide and pore-forming members to the surface of at least either the metal support 10 or the frame 20, and then performing a heat treatment while the metal support 10 and the frame 20 are held in close contact with each other. The heat treatment conditions can be appropriately set, for example, at 600° C. or higher and 1100° C. or lower, and for 0.5 hours or more and 24 hours or less. When the metal particles 41b are to be contained in the first adhering portion 41, it is sufficient that metal particles are appropriately added to the paste.

### [Second Adhering Portion 42]

The second adhering portion 42 is disposed between the metal support 10 and the frame 20. The second adhering portion 42 is sandwiched between the metal support 10 and the frame 20. The second adhering portion 42 is disposed on the side of the first adhering portion 41 opposite to the internal space 3a side. The second adhering portion 42 is formed in an annular shape so as to surround the first adhering portion 41. The second adhering portion 42 functions as a seal for sealing the internal space 3a.

The second adhering portion 42 is spaced apart from the first adhering portion 41 in the planar direction. In the region between the first adhering portion 41 and the second adhering portion 42, the metal support 10 and the frame 20 are in close contact with each other or are integrated with each other. It is preferable that the metal support 10 and the frame 20 are integrated together by welding or brazing in order to improve the electrical connection therebetween.

In the present embodiment, the second adhering portion 42 is embedded in a bottomed recess 70 formed between the metal support 10 and the frame 20. The cross section of the bottomed recess 70 is wedge-shaped. The bottomed recess 70 has a deepest portion 70a and an opening 70b. The opening 70b is open toward an external space 3b. The second adhering portion 42 is exposed to the external space 3b.

The second adhering portion 42 is constituted by Cr oxide. This makes it possible to suppress the diffusion of Cr from the metal support 10 and the frame 20 to the second adhering portion 42 during the manufacture and operation of the electrolysis cell 1. Furthermore, even if Cr diffuses from the metal support 10 and the frame 20 to the second adhering portion 42, the effect on the composition of the second adhering portion 42 is small, thus making it possible to suppress a decrease in the strength of the second adhering portion 42. Furthermore, since the metal support 10, the frame 20, and the second adhering portion 42 all contain Cr, the adhesion therebetween can be improved. Therefore, the adhesion between the metal support 10 and the frame 20 can be maintained for a long period of time.

The Cr content among the metal elements in the Cr oxide constituting the second adhering portion 42 can be, for example, 20 mol % or more and 100 mol % or less. It is preferable that the Cr content is 50 mol % or more. This makes it possible to significantly suppress the diffusion of Cr contained in the metal support 10 and the frame 20 to the second adhering portion 42.

It is preferable that the Cr oxide constituting the second adhering portion 42 is constituted by at least either chromium oxide or chromium manganese oxide. A property of these oxides is that the diffusion of Cr is particularly unlikely to occur, and therefore the durability of the second adhering portion 42 can be improved.

It is preferable that the Cr oxide constituting the second adhering portion 42 is crystalline. Accordingly, even when the electrolysis cell 1 is operated for a long period, it is possible to avoid the case where the second adhering portion 42 becomes damaged due to a phase transition of the Cr oxide from amorphous to crystalline.

It is preferable that the Cr oxide constituting the second adhering portion 42 has a spinel type or corundum type crystal structure. This makes it possible to improve the thermal stress resistance of the second adhering portion 42, and also to improve the bonding strength between the second adhering portion 42 and the metal support 10 and between the second adhering portion 42 and the frame 20.

Here, the second adhering portion 42 includes a void 42a therein, as shown in FIG. 3. This makes it possible for cracks formed in the second adhering portion 42 to be stopped at the void 42a. Therefore, brittle fracture of the second adhering portion 42 can be suppressed, and the adhesion between the metal support 10 and the frame 20 can be further maintained for a long period of time.

In the present embodiment, the second adhering portion 42 has one void 42a, but the number of voids 42a in one cross section is not particularly limited, and may be two or more.

It is preferable that, as shown in FIG. 3, the void 42a is spaced apart from the metal support 10 and the frame 20. This makes it possible to improve the adhesion between the second adhering portion 42 and the metal support 10 and between the second adhering portion 42 and the frame 20.

The void 42a may be elongated in the thickness direction parallel to the Z-axis direction. This allows cracks extending along the planar direction to be stopped over a wide range by the void 42a.

The void 42a may be elongated in the planar direction perpendicular to the Z-axis direction. This allows cracks extending along the thickness direction to be stopped over a wide range by the void 42a.

The void 42a may be elongated in a direction inclined with respect to both the thickness direction and the planar direction. This allows both cracks extending in the thickness direction and cracks extending in the planar direction to be stopped by the void 42a in a well-balanced manner.

It is preferable that the void 42a is located in the center portion of the second adhering portion 42 in the thickness direction. This makes it possible to reduce the difference in strength of the second adhering portion 42 on the metal support 10 side of the void 42a and the frame 20 side of the void 42a, and therefore makes it possible to suppress a decrease in the mechanical reliability of the second adhering portion 42. It is more preferable that the void 42a is entirely contained in the center portion of the second adhering portion 42 in the thickness direction.

It is preferable that the thickness of the void 42a is less than or equal to ¾ of the thickness of the second adhering portion 42. This makes it possible to suppress peeling of the second adhering portion 42 from the metal support 10 and the frame 20.

It is preferable that the ratio of the thickness of the void 42a to the thickness of at least either the metal support 10 or the frame 20 is 20 or more and 500 or less. As a result, the cracking stopping effect of the void 42a can be sufficiently exhibited, and it is possible to suppress a decrease in the mechanical reliability of the second adhering portion 42.

It is preferable that in a cross section of the second adhering portion 42, the ratio of the area of the void 42a to the area of the second adhering portion 42 is 5% or more and 30% or less. As a result, the cracking stopping effect of the void 42a can be sufficiently exhibited, and it is possible to suppress a decrease in the mechanical reliability of the second adhering portion 42.

It is preferable that the aforementioned area ratio in the planar end portion of the second adhering portion 42 exposed to the external space 3b is smaller than the aforementioned area ratio in the planar center portion. This makes it possible to suppress the case where the oxidant gas (O₂ in the present embodiment) flowing through the external space 3b enters the void 42a, thereby making it possible to further improve the sealing performance of the second adhering portion 42. The planar center portion of the second adhering portion 42 refers to the portion located in the center when the second adhering portion 42 is divided into three equal parts, on an imaginary line that is parallel to the planar direction and passes through the void 42a. The planar end portion of the second adhering portion 42 is the portion located on the external space 3b side of the planar center portion, on the imaginary line.

As shown in FIG. 3, it is preferable that the second adhering portion 42 includes metal particles 42b at least partially embedded in the Cr oxide. This makes it possible to improve the toughness of the second adhering portion 42.

The metal particles 42b may be entirely embedded in the Cr oxide, or may be partially exposed inside the void 42a. It is preferable that the metal particles 42b contain, as a main component, the same metal element as the main component of at least either the metal support 10 or the frame 20. This makes it possible to suppress a change in composition of the second adhering portion 42 caused by element diffusion from the metal support 10 and the frame 20. The metal particles 42b may contain, for example, Fe or Cr as a main component.

The second adhering portion 42 can be formed by applying a paste containing Cr oxide and pore-forming members to the surface of at least either the metal support 10 or the frame 20, and then performing a heat treatment while the metal support 10 and the frame 20 are held in close contact with each other. The heat treatment conditions can be appropriately set, for example, at 600° C. or higher and 1100° C. or lower, and for 0.5 hours or more and 24 hours or less. When the metal particles 42b are to be contained in the second adhering portion 42, it is sufficient that metal particles are appropriately added to the paste. Also, the second adhering portion 42 may be formed at the same time as the first adhering portion 41.

### 2. Second Embodiment

### (Electrolysis Cell 1)

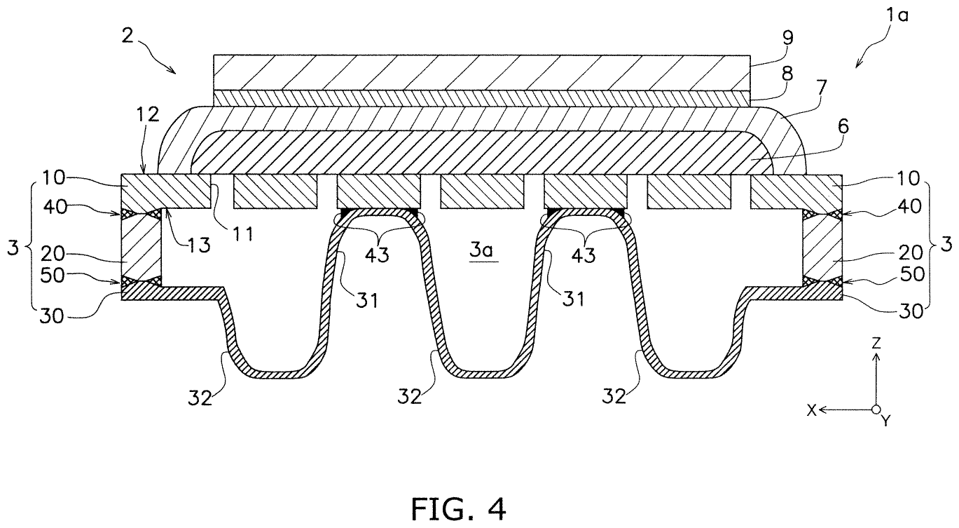

FIG. 4 is a cross-sectional view of an electrolysis cell la according to a second embodiment. The electrolysis cell la is an example of a “metal-supported electrochemical cell” according to the present invention.

The electrolysis cell la of the second embodiment differs from the electrolysis cell 1 of the first embodiment in that the interconnector 30 includes embossed portions 31 and debossed portions 32, and in that the chromium alloy container 3 includes third adhering portions 43. The following mainly describes the differences.

In the present embodiment, either the metal support 10 or the interconnector 30 is an example of a “first alloy member” according to the present invention, and the other one is an example of a “second alloy member” according to the present invention. The third adhering portions 43 are an example of an “adhering portion” according to the present invention.

As shown in FIG. 4, the interconnector 30 includes a plurality of embossed portions 31 and a plurality of debossed portions 32. In FIG. 4, two embossed portions 31 and three debossed portions 32 are shown, but the number of embossed portions 31 and the number of debossed portions 32 can be changed as appropriate.

The embossed portions 31 are in contact with the second main surface 13 of the metal support 10. As a result, the metal support 10 is supported by the interconnector 30, thus suppressing bending of the metal support 10. The embossed portions 31 only need to be in contact with the metal support 10 and do not need to be fixed to the metal support 10.

The debossed portions 32 protrude toward the side opposite to the metal support 10. The debossed portions 32 come into contact with an external power source or another electrolysis cell.

The third adhering portions 43 adhere the embossed portions 31 to the metal support 10. The third adhering portions 43 are disposed in the vicinity of the leading end portions of the embossed portions 31. The leading end portion of the embossed portion 31 refers to the portion of the embossed portion 31 that comes into contact with the metal support 10. It is preferable that the third adhering portions 43 are formed in an annular shape so as to surround the leading end portions of the embossed portions 31. This makes it possible to improve the adhesion between the embossed portions 31 and the metal support 10.

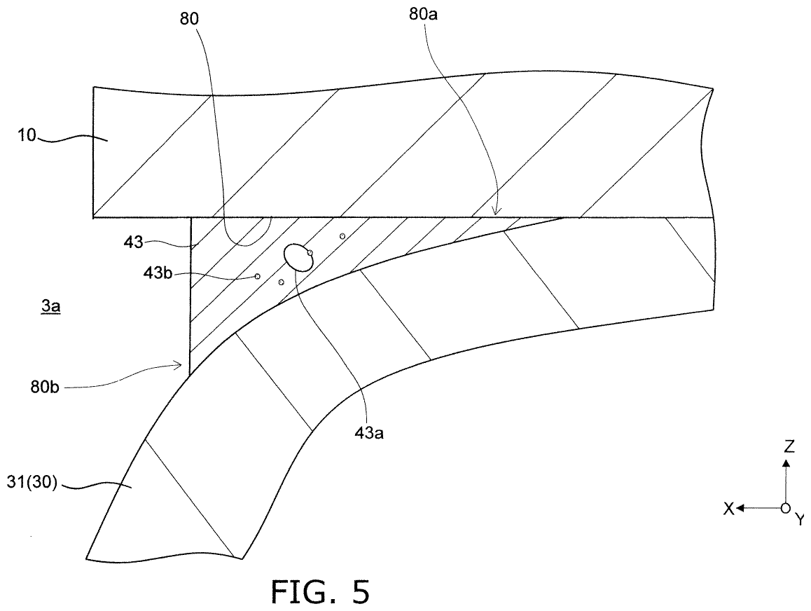

Here, FIG. 5 is an enlarged view of a portion of FIG. 4. A cross section of one third adhering portion 43 is shown in FIG. 5. The cross section illustrated in FIG. 5 is perpendicular to the second main surface 13 of the metal support 10.

The third adhering portion 43 is disposed between the metal support 10 and the embossed portion 31. The third adhering portion 43 is sandwiched between the metal support 10 and the embossed portion 31. The third adhering portion 43 is disposed on the metal support 10 and is formed in an annular shape so as to surround the leading end portion of the embossed portion 31.

In the present embodiment, the third adhering portion 43 is embedded in a bottomed recess 80 formed between the metal support 10 and the embossed portion 31. The cross section of the bottomed recess 80 is wedge-shaped. The bottomed recess 80 has a deepest portion 80a and an opening 80b. The opening 80b is open toward the internal space 3a. The third adhering portion 43 is exposed to the internal space 3a.

The third adhering portion 43 is constituted by Cr oxide. This makes it possible to suppress the diffusion of Cr from the metal support 10 and the embossed portion 31 to the third adhering portion 43 during the manufacture and operation of the electrolysis cell la. Furthermore, even if Cr diffuses from the metal support 10 and the embossed portion 31 to the third adhering portion 43, the effect on the composition of the third adhering portion 43 is small, thus making it possible to suppress a decrease in the strength of the third adhering portion 43. Furthermore, since the metal support 10, the embossed portion 31, and the third adhering portion 43 all contain Cr, the adhesion therebetween can be improved. Therefore, the adhesion between the metal support 10 and the embossed portion 31 can be maintained for a long period of time.

The Cr content among the metal elements in the Cr oxide constituting the third adhering portion 43 can be, for example, 20 mol % or more and 100 mol % or less. It is preferable that the Cr content is 50 mol % or more. This makes it possible to significantly suppress the diffusion of Cr contained in the metal support 10 and the embossed portion 31 to the third adhering portion 43.

It is preferable that the Cr oxide constituting the third adhering portion 43 is constituted by at least either chromium oxide or chromium manganese oxide. A property of these oxides is that the diffusion of Cr is particularly unlikely to occur, and therefore the durability of the third adhering portion 43 can be improved.

It is preferable that the Cr oxide constituting the third adhering portion 43 is crystalline. Accordingly, even when the electrolysis cell la is operated for a long period, it is possible to avoid the case where the third adhering portion 43 becomes damaged due to a phase transition of the Cr oxide from amorphous to crystalline.

It is preferable that the Cr oxide constituting the third adhering portion 43 has a spinel type or corundum type crystal structure. This makes it possible to improve the thermal stress resistance of the third adhering portion 43, and also to improve the bonding strength between the third adhering portion 43 and the metal support 10 and between the third adhering portion 43 and the interconnector 30.

Here, the third adhering portion 43 includes a void 43a therein, as shown in FIG. 5. This makes it possible for cracks formed in the third adhering portion 43 to be stopped at the void 43a. Therefore, brittle fracture of the third adhering portion 43 can be suppressed, and the adhesion between the metal support 10 and the interconnector 30 can be further maintained for a long period of time.

In the present embodiment, the third adhering portion 43 has one void 43a, but the number of voids 43a in one cross section is not particularly limited, and may be two or more.

It is preferable that, as shown in FIG. 5, the void 43a is spaced apart from the metal support 10 and the interconnector 30. This makes it possible to improve the adhesion between the third adhering portion 43 and the metal support 10 and between the third adhering portion 43 and the interconnector 30.

The void 43a may be elongated in the thickness direction parallel to the Z-axis direction. This allows cracks extending along the planar direction to be stopped over a wide range by the void 43a.

The void 43a may be elongated in the planar direction perpendicular to the Z-axis direction. This allows cracks extending along the thickness direction to be stopped over a wide range by the void 43a.

The void 43a may be elongated in a direction inclined with respect to both the thickness direction and the planar direction. This allows both cracks extending in the thickness direction and cracks extending in the planar direction to be stopped by the void 43a in a well-balanced manner.

It is preferable that the void 43a is located in the center portion of the third adhering portion 43 in the thickness direction. This makes it possible to reduce the difference in strength of the third adhering portion 43 on the metal support 10 side of the void 43a and the interconnector 30 side of the void 43a, and therefore makes it possible to suppress a decrease in the mechanical reliability of the third adhering portion 43. It is more preferable that the void 43a is entirely contained in the center portion of the third adhering portion 43 in the thickness direction.

It is preferable that the thickness of the void 43a is less than or equal to ¾ of the thickness of the third adhering portion 43. This makes it possible to suppress peeling of the third adhering portion 43 from the metal support 10 and the interconnector 30.

It is preferable that the ratio of the thickness of the void 43a to the thickness of at least either the metal support 10 or the interconnector 30 is 20 or more and 500 or less. As a result, the cracking stopping effect of the void 43a can be sufficiently exhibited, and it is possible to suppress a decrease in the mechanical reliability of the third adhering portion 43.

It is preferable that in a cross section of the third adhering portion 43, the ratio of the area of the void 43a to the area of the third adhering portion 43 is 5% or more and 30% or less. As a result, the cracking stopping effect of the void 43a can be sufficiently exhibited, and it is possible to suppress a decrease in the mechanical reliability of the third adhering portion 43.

It is preferable that the aforementioned area ratio in the planar end portion of the third adhering portion 43 exposed to the internal space 3a is smaller than the aforementioned area ratio in the planar center portion. This makes it possible to suppress the case where the oxidant gas (O₂ in the present embodiment) flowing through the internal space 3a enters the void 43a, thereby making it possible to further improve the sealing performance of the third adhering portion 43.

As shown in FIG. 5, it is preferable that the third adhering portion 43 includes metal particles 43b at least partially embedded in the Cr oxide. This makes it possible to improve the toughness of the third adhering portion 43.

The metal particles 43b may be entirely embedded in the Cr oxide, or may be partially exposed inside the void 43a. It is preferable that the metal particles 43b contain, as a main component, the same metal element as the main component of at least either the metal support 10 or the interconnector 30. This makes it possible to suppress a change in composition of the third adhering portion 43 caused by element diffusion from the metal support 10 and the interconnector 30. The metal particles 43b may contain, for example, Fe or Cr as a main component.

The third adhering portion 43 can be formed by applying a paste containing Cr oxide and pore-forming members to the surface of at least either the metal support 10 or the embossed portion 31, and then performing a heat treatment while the metal support 10 and the embossed portion 31 are held in close contact with each other. The heat treatment conditions can be appropriately set, for example, at 800° C. or higher and 1100° C. or lower, and for 0.5 hours or more and 24 hours or less. When the metal particles 43b are to be contained in the third adhering portion 43, it is sufficient that metal particles are appropriately added to the paste. Moreover, the third adhering portion 43 may be formed at the same time as the first and second adhering portions 41 and 42.

### (Variations)

Although embodiments of the present invention have been described above, the present invention is not limited to these embodiments, and various modifications can be made without departing from the spirit of the present invention.

### [Variation 1]

In the first and second embodiments, the frame 20 and the interconnector 30 are separate members, but the frame 20 and the interconnector 30 may be an integrated member. In this case, the chromium alloy container 3 does not include the second sealing portion 50.

### [Variation 2]

In the first and second embodiments, the metal support 10 and the frame 20 are separate members, but the metal support 10 and the frame 20 may be an integrated member. In this case, the chromium alloy container 3 does not include the first sealing portion 40.

### [Variation 3]

In the first and second embodiments, the first adhering portion 41 has a single-layer structure, but there is no limitation to this. The first adhering portion 41 may have a multi-layer structure including two or more layers constituted by Cr oxides having different compositions.

### [Variation 4]

In the first and second embodiments, the second adhering portion 42 has a single-layer structure, but there is no limitation to this. The second adhering portion 42 may have a multi-layer structure including two or more layers constituted by Cr oxides having different compositions.

### [Variation 5]

In the second embodiment, the third adhering portion 43 has a single-layer structure, but there is no limitation to this. The third adhering portion 43 may have a multi-layer structure including two or more layers constituted by Cr oxides having different compositions.

### [Variation 6]

In the first and second embodiments, the first sealing portion 40 includes the first adhering portion 41 and the second adhering portion 42, but may include only either the first adhering portion 41 or the second adhering portion 42.

Also, the second sealing portion 50 has the same configuration as the first sealing portion 40, but may have a different configuration from the first sealing portion 40. The second sealing portion 50 may have only either the first adhering portion 41 or the second adhering portion 42.

### [Variation 7]

In the first and second embodiments, the metal support 10 and the frame 20 are in close contact with or integrated with each other between the first adhering portion 41 and the second adhering portion 42, but there is no limitation to this. The metal support 10 and the frame 20 do not need to be in close contact with each other or integrated with each other.

### [Variation 8]

In the above embodiments, an electrolysis cell has been described as an example of an electrochemical cell, but the electrochemical cell is not limited to an electrolysis cell. An electrochemical cell is a general term for an element in which a pair of electrodes are arranged so that electromotive force is produced from an overall oxidation-reduction reaction in order to convert electrical energy into chemical energy, and for an element for converting chemical energy into electrical energy. Thus, electrochemical cells include, for example, fuel cells that use oxide ions or protons as carriers.

### [Variation 9]

In the above embodiments, the chromium alloy container according to the present invention is applied to an electrochemical cell, but the chromium alloy container can be used for various purposes. The chromium alloy container can be applied to, for example, a methanation reactor for synthesizing methane from hydrogen and carbon dioxide.

### WORKING EXAMPLES

Working examples of the chromium alloy container according to the present invention will be described below. However, the present invention is not limited to the working examples described below.

### Samples No. 1 to 7

Chromium alloy containers 3 (see FIG. 3) according to Samples No. 1 to 7 were manufactured as follows.

First, for each sample, a paste containing Cr₂O₃ and pore-forming members (specifically, PMMA particles) was applied to the outer peripheral portion of the second main surface 13 of the metal support 10, and then the frame 20 was placed on the paste to produce a laminate. At this time, the ratio of the thickness of voids 41a to the thickness of the first adhering portion 41 was varied by changing the applied amount of paste and the particle size of the pore-forming members, as shown in Table 1.

Next, the metal support 10 and the frame 20 were lap-welded to integrate the metal support 10 and the frame 20 with each other between the first adhering portion 41 and the second adhering portion 42.

Next, the laminate was subjected to a heat treatment (1000° C., 1 hour) such that the first adhering portion 41 having voids 41a therein and the second adhering portion 42 having voids 42a therein were formed from the paste. As a result, the chromium alloy container 3 having the first and second adhering portions 41 and 42 was obtained.

Next, a heat endurance test was carried out by subjecting the chromium alloy container 3 to a heat treatment (800° C., 1000 hours).

Next, the chromium alloy container 3 was cut along the thickness direction to expose a cross section of the first adhering portion 41 along the thickness direction.

Next, as described in the above embodiments, the ratio of the thickness of the voids 41a to the thickness of the first adhering portion 41 in the cross section of the first adhering portion 41 was measured. The measured thickness ratios are shown in Table 1.

Next, the cross section of the first adhering portion 41 was observed with an SEM (5000 times magnification) to check for the occurrence of peeling of the first adhering portion 41 from the metal support 10 and the frame 20 in the vicinity of the voids 41a in the first adhering portion 41. The peeling results are shown in Table 1.

TABLE 1

| | Ratio of thickness of voids | Peeling of |
|---|---|---|
| Sample | 41a to thickness of first | first adhering |
| No. | adhering portion 41 | portion 41 |
| 1 | 1/10 | No |
| 2 | 1/5 | No |
| 3 | 1/2 | No |
| 4 | 2/3 | No |
| 5 | 3/4 | No |
| 6 | 4/5 | Yes |
| 7 | 5/6 | Yes |

As shown in Table 1, in Samples No. 1 to 5 in which the ratio of the thickness of the voids 41a to the thickness of the first adhering portion 41 is ¾ or less, peeling of the first adhering portion 41 from the metal support 10 and the frame 20 after the heat endurance test was suppressed. Based on this, it was found that by setting the ratio of the thickness of the voids 41a to the thickness of the first adhering portion 41 to ¾ or less, it is possible to suppress a decrease in the strength of the first adhering portion 41 on the metal support 10 side of the voids 41a and on the frame 20 side of the voids 41a.

Although not shown in Table 1, results the same as those for the first adhering portion 41 were obtained for the second adhering portion 42.

### Samples No. 8 to 18

Chromium alloy containers 3 (see FIG. 3) according to Samples No. 8 to 18 were manufactured as follows.

First, for each sample, a paste containing Cr₂O₃ and pore-forming members (specifically, PMMA particles) was applied to the outer peripheral portion of the second main surface 13 of the metal support 10, and then the frame 20 was placed on the paste to produce a laminate. At this time, the ratio of the thickness of the metal support 10 to the thickness of voids 41a was varied by changing the particle size of the pore-forming members, as shown in Table 2.

Next, the metal support 10 and the frame 20 were lap-welded to integrate the metal support 10 and the frame 20 with each other between the first adhering portion 41 and the second adhering portion 42.

Next, the laminate was subjected to a heat treatment (1000° C., 1 hour) such that the first adhering portion 41 having voids 41a therein and the second adhering portion 42 having voids 42a therein were formed from the paste. As a result, the chromium alloy container 3 having the first and second adhering portions 41 and 42 was obtained.

Next, a heat endurance test was carried out by subjecting the chromium alloy container 3 to a heat treatment (800° C., 1000 hours).

Next, the chromium alloy container 3 was cut along the thickness direction to expose a cross section of the first adhering portion 41 along the thickness direction.

Next, as described in the above embodiments, the ratio of the thickness of the metal support 10 to the thickness of the voids 41a was measured. The measured thickness ratios are shown in Table 2.

Next, the cross section of the first adhering portion 41 was observed with an SEM (5000 times magnification) to measure the length of the largest crack that was formed inside the first adhering portion 41. The largest crack is the crack with the longest linear length between the two ends among all of the cracks observed in five fields of view. The lengths of the largest cracks (linear distance between the ends) are shown in Table 2.

TABLE 2

| | Ratio of thickness of metal | Largest crack |
|---|---|---|
| Sample | support 10 to thickness of | length |
| No. | voids 41a | (mm) |
| 8 | 20 | 0.07 |
| 9 | 25 | 0.03 |
| 10 | 50 | 0.01 |
| 11 | 100 | 0.02 |
| 12 | 300 | 0.05 |
| 13 | 400 | 0.06 |
| 14 | 500 | 0.08 |
| 15 | 5 | 1.1 |
| 16 | 10 | 0.8 |
| 17 | 600 | 0.7 |
| 18 | 1000 | 1.0 |

As shown in Table 2, in Samples No. 8 to 14 in which the ratio of the thickness of the metal support 10 to the thickness of the voids 41a was set to 20 or more and 500 or less, the length of the largest crack could be significantly shortened. Based on this, it was found that by setting the ratio of the thickness of the metal support 10 to the thickness of the voids 41a to 20 or more and 500 or less, the cracking stopping effect of the voids 41a can be sufficiently exhibited while also suppressing a decrease in the strength of the first adhering portion 41.

Although not shown in Table 2, results the same as those for the first adhering portion 41 were obtained for the second adhering portion 42.

### Samples No. 19 to 27

Chromium alloy containers 3 (see FIG. 3) according to Samples No. 19 to 27 were manufactured as follows.

First, for each sample, a paste containing Cr₂O₃ and pore-forming members (specifically, PMMA particles) was applied to the outer peripheral portion of the second main surface 13 of the metal support 10, and then the frame 20 was placed on the paste to produce a laminate. At this time, the ratio of the area of the voids 41a to the area of the first adhering portion 41 was varied as shown in Table 3 by changing the added amount and the particle size of the pore-forming members.

Next, the metal support 10 and the frame 20 were lap-welded to integrate the metal support 10 and the frame 20 with each other between the first adhering portion 41 and the second adhering portion 42.

Next, the laminate was subjected to a heat treatment (1000° C., 1 hour) such that the first adhering portion 41 having the voids 41a therein and the second adhering portion 42 having the voids 42a therein were formed from the paste. As a result, the chromium alloy container 3 having the first and second adhering portions 41 and 42 was obtained.

Next, a heat endurance test was carried out by subjecting the chromium alloy container 3 to a heat treatment (800° C., 1000 hours).

Next, the chromium alloy container 3 was cut along the thickness direction to expose a cross section of the first adhering portion 41 along the thickness direction.

Next, as described in the above embodiments, the ratio of the area of the voids 41a to the area of the Cr oxide in the cross section of the first adhering portion 41 was calculated. The calculated area ratios are shown in Table 3.

Next, the cross section of the first adhering portion 41 was observed with an SEM (5000 times magnification) to measure the length of the largest crack that was formed inside the first adhering portion 41. The largest crack is the crack with the longest linear length between the two ends among all of the cracks observed in five fields of view. If the entirety of a crack could not fit in the observation field, the field was appropriately slid to acquire multiple images, which were then stitched together to measure the crack length. The lengths of the largest cracks (linear distance between the ends) are shown in Table 3.

TABLE 3

| | Ratio of area of voids 41a to | Largest crack |
|---|---|---|
| Sample | area of first adhering portion 41 | length |
| No. | (%) | (mm) |
| 19 | 5 | 0.07 |
| 20 | 10 | 0.03 |
| 21 | 20 | 0.01 |
| 22 | 25 | 0.05 |
| 23 | 30 | 0.08 |
| 24 | 2 | 1.0 |
| 25 | 4 | 0.5 |
| 26 | 35 | 0.8 |
| 27 | 50 | 1.1 |

As shown in Table 3, in Samples No. 19 to 23 in which the ratio of the area of the voids 41a to the area of the first adhering portion 41 was 5% or more and 30% or less, the length of the largest crack could be significantly shortened. Based on this, it was found that by setting the ratio of the area of the voids 41a to the area of the first adhering portion 41 to 5% or more and 30% or less, the cracking stopping effect of the voids 41a can be sufficiently exhibited while also suppressing a decrease in the strength of the first adhering portion 41.

Although not shown in Table 2, results the same as those for the first adhering portion 41 were obtained for the second adhering portion 42.

### Samples No. 28 to 34

Chromium alloy containers according to Samples No. 28 to 34 were manufactured as follows.

First, for each sample, a paste containing at least either Cr₂O₃ or Mn₃O₄ and pore-forming members (specifically, PMMA particles) was applied to the outer peripheral portion of the second main surface 13 of the metal support 10, and then the frame 20 was placed on the paste to produce a laminate. At this time, the Cr content among the metal elements in the Cr oxide constituting the bonded joint was varied as shown in Table 1 by changing the added amounts of Cr₂O₃ and Mn₃O₄. However, the amount and particle size of the pore-forming members were the same in all samples.

Next, the laminate was subjected to a heat treatment (1000° C., 1 hour) such that the first adhering portion 41 having the voids 41a therein and the second adhering portion 42 having the voids 42a therein was formed from the paste. As a result, the chromium alloy container having the first and second adhering portions 41 and 42 was obtained. Note that in these working examples, the metal support 10 and the frame 20 were not welded or brazed.

Next, the composition of the Cr oxide constituting the adhering portion was analyzed using an EDS device to measure the Cr content among the metal elements in the Cr oxide. The Cr content at this time is shown in Table 4 as “Cr content before heat endurance test”.

Next, a heat endurance test was carried out by

subjecting the chromium alloy container to a heat treatment (800° C., 1000 hours).

Next, the composition of the Cr oxide constituting the adhering portion was analyzed using an EDS device, and the Cr content among the metal elements in the Cr oxide was measured again. The Cr content at this time is shown in Table 4 as “Cr content after heat endurance test”.

TABLE 4

| | Cr concentration | Cr concentration | |
|---|---|---|---|
| | before heat | after heat | Change in Cr |
| Sample | treatment | treatment | concentration |
| No. | (mol %) | (mol %) | (mol %) |
| 28 | 30.0 | 33.0 | 3.0 |
| 29 | 40.0 | 42.0 | 2.0 |
| 30 | 50.0 | 50.2 | 0.2 |
| 31 | 60.0 | 60.2 | 0.2 |
| 32 | 80.0 | 80.1 | 0.1 |
| 33 | 100.0 | 100.0 | 0.0 |
| 34 | <0.1 | 18.0 | 17.9-18.0 |

As shown in Table 4, in Samples No. 30 to 33, in which the Cr content among the metal elements in the Cr oxide constituting the adhering portion was set to 50 mol % or more, the change in Cr content before and after the heat endurance test was significantly reduced. Based on this, it was found that by setting the Cr content among the metal elements in the Cr oxide constituting the adhering portion to 50 mol % or more, it is possible to significantly suppress the diffusion of Cr contained in the metal support 10 and the frame 20 to the adhering portion.

### REFERENCE SIGNS LIST

1, 1a Electrolysis cell
2 Cell body portion
3 Chromium alloy container
3a Internal space
6 Hydrogen electrode
7 Electrolyte
8 Reaction prevention layer
9 Oxygen electrode
10 Metal support
11 Supply hole
12 First main surface
13 Second main surface
20 Frame
30 Interconnector
31 Embossed portion
40 First sealing portion
41 First adhering portion
42 Second adhering portion
43 Third adhering portion
41a, 42a, 43a Voids
41b, 42b, 43b Metal particles

1. A chromium alloy container having an internal space, comprising:
a first alloy member constituted by an alloy containing chromium;
a second alloy member constituted by an alloy containing chromium; and
an adhering portion adhering the first alloy member and the second alloy member to each other, wherein
the adhering portion is constituted by an oxide containing chromium as a main component, and
the adhering portion has a void therein.

2. The chromium alloy container according to claim 1, wherein
the void is spaced apart from the first alloy member and the second alloy member.

3. The chromium alloy container according to claim 1, wherein
the void is elongated in a thickness direction of the adhering portion.

4. The chromium alloy container according to claim 1, wherein
the void is elongated in a planar direction perpendicular to a thickness direction of the adhering portion.

5. The chromium alloy container according to claim 1, wherein
the void is elongated in a direction inclined with respect to both a thickness direction of the adhering portion and a planar direction perpendicular to the thickness direction.

6. The chromium alloy container according to claim 1, wherein
the void is located in a center portion in a thickness direction of the adhering portion.

7. The chromium alloy container according to claim 1, wherein
in a thickness direction of the adhering portion, a thickness of the void is less than or equal to ¾ of a thickness of the adhering portion.

8. The chromium alloy container according to claim 1, wherein
in a thickness direction of the adhering portion, a ratio of a thickness of at least either the first alloy member or the second alloy member to a thickness of the void is 20 or more and 500 or less.

9. The chromium alloy container according to claim 1, wherein
in a cross section of the adhering portion, a ratio of an area of the void to an area of the adhering portion is 5% or more and 30% or less.

10. The chromium alloy container according to claim 1, wherein
the adhering portion includes metal particles at least partially embedded in the oxide.

11. The chromium alloy container according to claim 1, wherein
a chromium content among metal elements in the oxide is 50 mol % or more.

12. The chromium alloy container according to claim 1, wherein
the oxide is constituted by at least either chromium oxide or chromium manganese oxide.

13. The chromium alloy container according to claim 1, wherein
the oxide is crystalline.

14. The chromium alloy container according to claim 13, wherein
the oxide has a spinel type crystal structure or a corundum type crystal structure.

15. The chromium alloy container according to claim 1, wherein
the adhering portion is a seal for sealing the internal space.

16. The chromium alloy container according to claim 1, wherein
the second alloy member has an embossed portion in contact with the first alloy member, and
the adhering portion adheres the embossed portion to the first alloy member.

17. A metal-supported electrochemical cell comprising:
the chromium alloy container according to claim 1; and
a cell body portion disposed on the chromium alloy container, wherein
the first alloy member has a plurality of communication holes in communication with the internal space, and
the cell body portion is disposed on the first alloy member in such a manner as to cover the plurality of communication holes.
